(19) United States
(12) Patent Application Publication
(10) Pub. No.: US 2004/0190387 A1
(43) Pub. Date: Sep. 30, 2004

(54) Turntable

(75) Inventors: Keisuke Ishii, Isesaki-shi (JP); Masahisa Tsuchiya, Isesaki-shi (JP)

Correspondence Address: JORDAN AND HAMBURG LLP, 122 EAST 42ND STREET, SUITE 4000, NEW YORK, NY, 10168, US

(73) Assignee: Tokyo Parts Industrial Co., Ltd., Isesaki-shi (JP)

(21) Appl. No.: 10/766,583

(22) Filed: Jan. 27, 2004

(30) Foreign Application Priority Data
Jan. 31, 2003 (JP) 2003-023278

(51) Int. Cl. G11B 7/085

(52) U.S. Cl. 369/30.03

(57) ABSTRACT

A turntable comprises a guide portion concentric with a rotary shaft for rotary driving an information recording disk and a ring-like centering member for centering the information recording disk by employing a central hole is provided in the information recording disk the centering member being provided so that it can move up and down so that the outer peripheral surface of the guide portion and the inner peripheral surface of the centering member face each other, wherein the centering member applies pressure to the inner periphery of the central hole of the information recording disk during rotation, thereby pressing it against the guide portion. As a result, the guide portion is elastically deformed and the centering accuracy of a disk carried on a turntable is maintained.

### BACKGROUND OF THE INVENTION

1. Field of the Invention

The present invention relates to a turntable mounted on a motor of a disk drive apparatus and having a holding mechanism for holding an information recording disk.

2. Description of the Related Art

In recent years the rotation speed of disk rotary drive units carried on information recording disk reproduction/recording units (referred to hereinbelow as a disk), such as for CD-ROM and DVD, has been increased in order to reproduce data recorded on a disk or to record data thereon with a high speed.

Furthermore, because the in-plane weight distribution in such disks is non-uniform, the eccentric force applied to the disk can increase as the rotation speed is increased.

The turntables having a disk holding mechanism carried on a disk rotary drive unit for holding and rotating such a disk are required to be able to hold the disk reliably so as to prevent the disk from falling down, vibrating, or displacing during rotation.

The conventional mechanism for holding disks is described below.

(1) A turntable in which both the guide portion integrated with a member constituting a unit for carrying the disk and the centering member provided at the guide portion so that it is free to move up and down are composed of a metal (for example Japanese Patent Application Laid-open No. H8-249808).

In this turntable, as shown in FIG. 6, the centering member 30 comprises a first taper portion 30a for centering the disk and a second taper portion 30b for guiding the disk, and the disk is rotated, while being centered by contact with the first taper portion 30a during rotation.

However, in the turntable made of a metal, as described in Japanese Patent Application Laid-open No. H8-249808, if a disk D (with an eccentric center of gravity) with a non-uniform in-plane weight distribution is rotary driven at a high rate, a large eccentric force acts upon the disk D. As a result, the disk is pressed against one point of the first taper portion 30a. In such a case, if the disk is raised by the force component created by the first taper portion 30a, the centering member is simultaneously pushed inward. If the centering member moves inward, the disk moves in the radial direction and the centering accuracy is lost, causing a tracking error or decreasing the force holding the disk.

Furthermore, the kinetic energy in the axial direction that was stored in the contracted spring which applies a force to the centering member 30 acts in the direction of pushing the disk up from the turntable and the disk can be detached or fly out from the turntable T.

Those problems easily occur because the friction force generated between the guide portion 2c and centering member 30 is small since the two members are made of a metal, as in Japanese Patent Application Laid-open No. H8-249808.

### SUMMARY OF THE INVENTION

It is an object of the present invention to provide a turntable for a disk, which resolves the above-described problems.

In order to resolve the above-described problems, the present invention provides a turntable comprising a centering member movable in the rotary shaft direction for positioning a disk with respect to the rotary shaft, and a guide portion which is pushed and elastically deformed by the centering member during disk rotation and serves for guiding the centering member in the axial direction, wherein the guide portion is formed concentrically with the rotary shaft.

For example, the object can be attained by reducing the rigidity of the guide portion with respect to that of the centering member, as structural means allowing for elastic deformation of the guide portion.

More specifically, a thin portion may be provided in part of the guide portion and the rigidity of the guide portion may be reduced with respect to that of the centering member.

Further, the object can be also attained by composing the guide portion from a material that is softer than the material of the centering member, as structural means allowing for elastic deformation of the guide portion.

More specifically, the guide portion may be formed from a resin, and the centering member may be formed from a metal.

Further, the centering member can be composed of a polycarbonate or a resin harder than a polycarbonate, and the guide portion can be composed of a material softer than polycarbonates.

In the above-described configurations of turntables, a gap may be ensured inside the guide portion, and a space may be ensured during plastic deformation of the guide portion.

### BRIEF DESCRIPTION OF THE DRAWINGS

FIG. 1 is a cross-sectional view of a turntable for a disk illustrating a first embodiment of the present invention;

FIG. 2(a) is a cross-sectional view illustrating a state in which an eccentric force is not applied from the disk D to the centering member 3;

FIG. 2(b) is a cross-sectional view illustrating a state in which an eccentric force is applied from the disk D to the centering member 3 and the guide 2c is elastically deformed;

FIG. 3(A-1) is a cross-sectional view illustrating a state in which an eccentric force is applied from the disk D to the centering member 3 and the guide 2c is elastically deformed;

FIG. 3(A-2) is an enlarged view of the contact portion 2e of the two members in the axial direction in the state shown in FIG. 3(A-1);

FIG. 3(B-1) is a cross-sectional view illustrating the conventional turntable in which an eccentric force is applied from the disk D to the centering member 3;

FIG. 3(B-2) is an enlarged view of the contact portion 20e of the two members in the axial direction in the state shown in FIG. 3(B-1);

FIGS. 4(a) and 4(b) are cross-sectional views of the turntable T for a disk for further embodiments of the present invention; and

FIG. 5 is a cross-sectional view of a conventional turntable.

### DESCRIPTION OF THE PREFERRED EMBODIMENTS

The first embodiment of the present invention will be described hereinbelow with reference to the drawings.

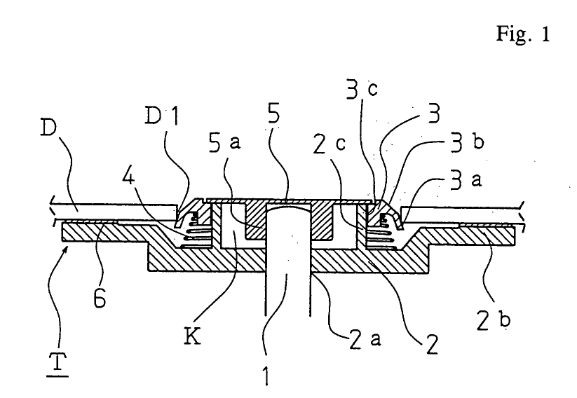

FIG. 1 is a cross-sectional view of a turntable T for a disk illustrating the first embodiment of the present invention.

Referring to FIG. 1, a shaft 1 which is an output shaft of a motor serving as a drive source for rotary driving the turntable T carrying a disk D is fixed to a base 2 formed from a resin by press fitting into a shaft mounting hole 2a provided in the base 2.

Further, a sliding stopper 6 for preventing the disk D from moving in the rotation direction during high-speed rotation is arranged at the disk carrying portion 2b constituting the base 2.

Similarly, in a guide portion 2c constituted on the base 2, a round cylinder concentric with the shaft 1 rises from the base 2. A centering member 3 formed from a resin is provided outwardly of the guide portion 2c, this member serving for centering the disk D by bringing it into contact with the inner peripheral surface D1 of the central hole of the disk D.

The centering member 3 is mounted so that it is free to move up and down in the axial direction, while sliding along the guide portion 2c, by introducing a spring 4 between the base 2 and the centering member 3. Furthermore, the centering member 3 is constructed so as to be prevented from detachment with a stopper 5 mounted by pressing in the shaft 1.

Furthermore, the centering member 3 has a ring-like shape, when viewed from the axial direction thereof, and the guide portion 2c is positioned so as to face the inner peripheral surface 3c of the central hole of the centering member 3.

Moreover, a sufficient gap K is ensured between the guide portion 2c and the stopper mounting portion 5a (inward of the guider portion 2c).

The centering member 3 and guide portion 2c are composed of materials with different properties. This is because if the two members are made from the same material, the parts are degraded when they rub together over a large number of cycles and the wear of the two materials increases. As a result, the operation of the centering member 3 is degraded causing malfunction.

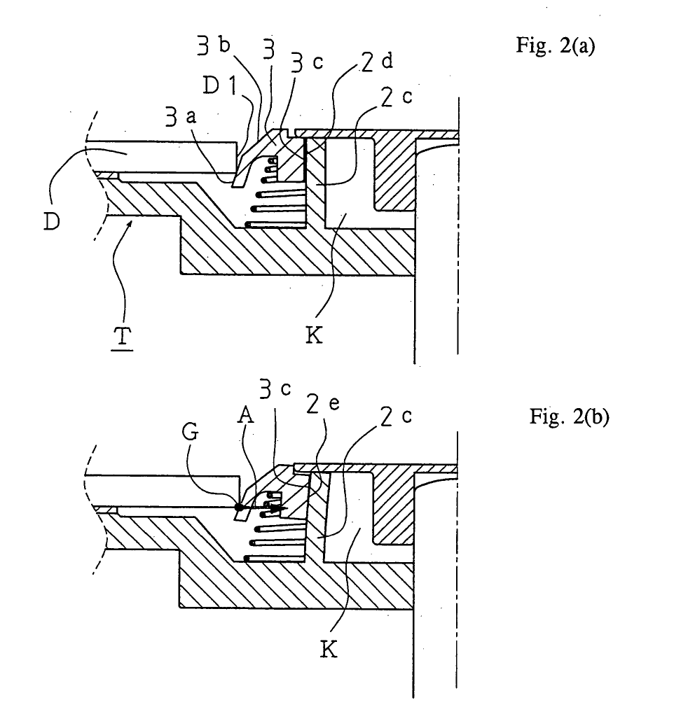

The state in which the turntable of the above-described configuration carries the disk D and rotates at a high speed will be described hereinbelow with reference to FIG. 2.

FIG. 2(a) illustrates a state in which no eccentric force acts from the disk D upon the centering member 3.

FIG. 2(b) illustrates a state in which an eccentric force acts from the disk D upon the centering member 3 in point G at the right side of the figure (arrow A) and the guide 2c is elastically deformed.

In the turntable of the above-described configuration, a certain clearance 2d is provided between the two members so that the centering member 3 can smoothly raise and lower the guide 2c, thereby providing for smooth centering of the disk D. Therefore, in the state shown in FIG. 2(a), even if the guide portion 2c is brought into contact with the inner peripheral surface 3c of the central hole of the centering member 3 and has a contact portion 2e, the contact surface area between the two members where the circles of different diameter are in contact is very small.

However, when a disk that has an eccentric center of gravity is rotated at a high speed, the disk moves in the radial direction under the effect of an eccentric force generated by the disk and applies pressure to the centering member 3. In the centering member 3, the pressing force applied by the disk D is received by the first taper portion 3a. Therefore, this pressing force is generated in the axial direction (direction of contracting the spring 4) and radial direction. As a result, a force applying pressure to the guide portion 2c and a force acting in the axial direction act upon the centering member 3.

Under the effect of the force applied by the disk and pushing the centering member 3 in the direction of arrow A, the inner peripheral surface 3c of the central hole of the centering member 3 is brought into contact with the outer peripheral surface of the guide portion 2c.

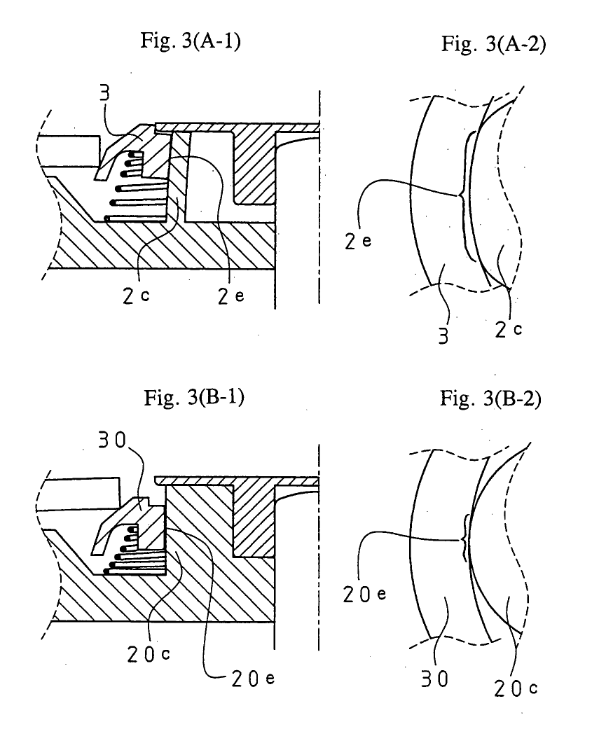

Further, the guide portion 2c which is pushed by the centering member 3 has a sufficient gap K on the inside thereof and is formed from a resin. Therefore, it can deform elastically. The zone of the guide portion 2c to which the pressure is applied is deformed so that the diameter of the guide portion increases, as shown in FIG. 3(A-2), and the contact surface area of the contact portion 2e of the guide portion 2c and centering member 3 increases. In such a case, the friction force between the guide portion 2c and centering member 3 increases. Therefore, the centering member 3 cannot easily move in the axial direction (direction of contracting the spring 4) (see FIG. 3A-2).

Therefore, the centering member 3 is not displaced significantly in the axial direction. As a result, the disk centering accuracy can be maintained and a tracking error can be prevented.

Furthermore, because the centering member 3 is not displaced significantly in the axial direction, it is not necessary to contract the spring 4 more than required, the useless repulsion force of the spring 4 can be reduced, and the detachment or flying of the disk caused thereby can be prevented.

Furthermore, movement caused by the force component in the radial direction is controlled by such elastic deformation. Further, because within the framework of the conventional technology, FIG. 3(B-1) and FIG. 3(B-2), by contrast with the above-described invention of the present application, the centering member 30 and the guide portion 20c are composed of a metal such as brass, the contact surface area 20e of the guide portion and centering member cannot be increased by causing elastic deformation of the guide portion (see FIG. 3(B-1)) as is the case in the invention of the present application.

Therefore, the friction force between the members cannot be increased, the centering member 30 moves significantly in the axial direction (direction of contracting the spring) under the effect of a pressing force applied by the disk that is moved by the eccentric force, and the disk centering function is lost (see FIG. 3(B-1)).

As a result, a tracking error, disk flying or detachment, and other problems were encountered during high-speed rotation of the disk in the turntable constructed according to the conventional technology.

The second embodiment of the present invention will now be described. In the second embodiment, because a resin which is softer than the resin constituting the centering member 3 is used for the resin constituting the guide portion 2c, the effect obtained can be equal to or better than that of the first embodiment.

More specifically, the combinations of materials shown in the following Table can be used for the components employed as the centering member 3 and guide portion 2c.

TABLE ILLUSTRATING THE COMBINATION
OF MATERIALS OF THE CENTERING
MEMBER AND THE GUIDE PORTION

| | MATERIAL OF | MATERIAL |
|---|---|---|
| | CENTERING | OF GUIDE |
| | MEMBER (3, 30) | PORTION (2c, 20c) |
| COMBINATION 1 | PPS | PC |
| COMBINATION 2 | PPS | ABS |
| COMBINATION 3 | PPS | POM |

PPS: POLYPHENYLENE SULFIDE
POM: POLYACETAL
PC: POLYCARBONATE
ABS: ACRYLONITRILE - BUTADIENE - STYRENE

Because a polycarbonate is used for the disk, the endurance of the centering member 3 can be increased by using a polycarbonate or a resin harder than polycarbonates as a material for the centering member 3 .

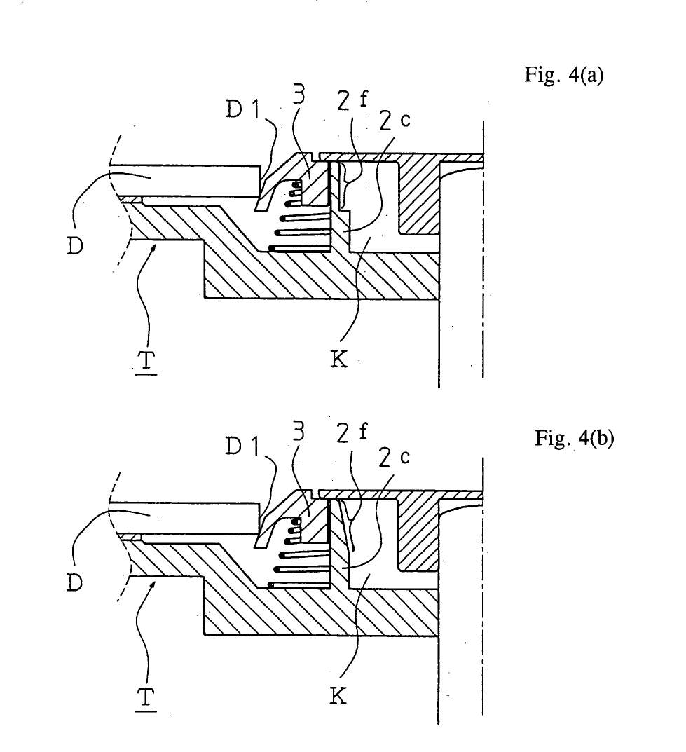

The third embodiment of the present invention will now be described. In the turntable T shown in FIGS. 4(a), (b), a thin portion 2f is provided in part of the guide portion 2c to reduce the rigidity of guide portion 2c with respect to that of the centering member 3.

Those guide portions may also constitute a plurality of slits arranged with an appropriate spacing in the axial direction in the cylindrical rising portion.

Providing the guide portions in such a manner makes it possible to change locally the rigidity of the member, in addition to obtaining effects identical to those of the first embodiment. As a result, the amount of elastic deformation of the guide portion 2c can be adjusted, the contact surface area of the centering member 3 and the guide portion 2c can be adjusted, and a friction force generated between the two members can be also adjusted.

Therefore, some design changes of the guide portion 2c make it possible to provide a variety of turntables for different conditions of use. Moreover, cost-efficient turntables can be provided.

The fourth embodiment of the present invention will now be described. In the fourth embodiment, the guide portion 2c is composed of a resin and the centering member 3 is composed of a metal, whereby an effect identical to that of the first embodiment can be obtained.

Because metals have higher processing accuracy than resins, a centering member of perfect shape can be produced. Therefore, when the disk centering is conducted with a centering member made from a metal, the centering accuracy is higher than that obtained when the centering is conducted with a centering member made from a resin.

With the configuration of components described, the centering member which is pushed by the eccentric force generated by a high-speed rotation of the disk with an eccentric center of gravity applies pressure to and elastically deforms the guide portion. As a result, the contact surface area of the guide portion and the centering member is increased, a friction force between the guide portion and the centering member is increased, and the centering member is prevented from moving in the axial direction.

Therefore, because the centering member is not displaced significantly in the axial direction, the centering accuracy of the disk can be maintained, and a tracking error can be prevented. Furthermore, because the centering member is not displaced significantly in the axial direction, the spring for applying a force is not contracted more than necessary, the useless repulsion force of the spring can be reduced, and the detachment or flying of the disk caused thereby can be prevented.

With the configuration of parts described, the guide portion can be elastically deformed to a large degree when an external force is applied. Therefore, the guide portion can be elastically deformed to a large degree by an external force received from the centering member to which an eccentric force of the disk is applied.

With the configuration of parts described, the rigidity of members can be locally changed. As a result, the quantity of elastic deformation of the guide portion can be adjusted, the contact surface area of the centering member and the guide portion can be adjusted, and a friction force generated between the two members can be also adjusted.

Therefore, some design changes of the guide portion 2c make it possible to provide a variety of turntables for different conditions of use. Moreover, cost-efficient turntables can be provided.

Further, with the configuration of parts described, composing the centering member of a metal makes it possible to improve the centering accuracy as compared with the case in which the centering member was composed of a resin.

Moreover, with the configuration of parts described, because the material used for the disk can be a polycarbonate, the endurance of the centering member can be especially improved by using a polycarbonate or a resin which is harder than a polycarbonate as a material employed for the centering member.

With the configuration of parts described, because a gap K is provided inside the guide portion, the guide portion can be elastically deformed.

FIG. 1

1 SHAFT

2 BASE

2a SHAFT MOUNTING HOLE

2b DISK CARRYING PORTION

2c GUIDE PORTION

3 CENTERING MEMBER

3a FIRST TAPER PORTION

3b SECOND TAPER PORTION

3c INNER PERIPHERAL SURFACE OF CENTRAL HOLE OF CENTERING PORTION

4 SPRING

5 STOPPER

5a STOPPER MOUNTING PORTION

6 SLIDING STOPPER

D DISK

D1 INNER PERIPHERAL SURFACE OF DISK CENTRAL HOLE

K GAP

T TURNTABLE

FIG. 2(a), FIG. 2(b)

2d CLEARANCE

2e CONTACT PORTION

2c GUIDE PORTION

3 CENTERING MEMBER

A ARROW

G FORCE APPLICATION POINT

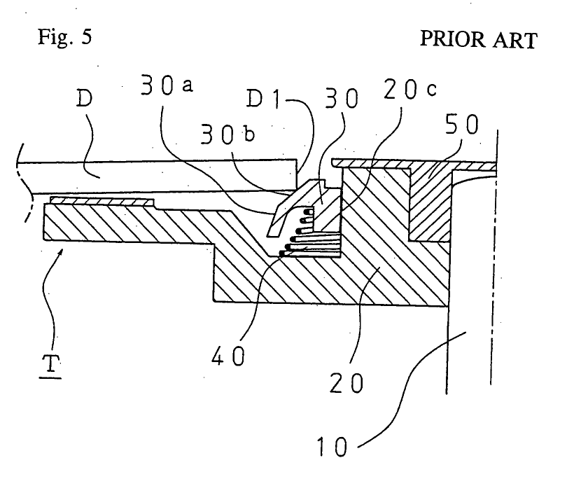

FIG. 5

SHAFT

BASE

20c Guide portion

centering member

first taper portion

second taper portion

spring

stopper

disk

turntable

What we claim is:

1. A turntable comprising:
a turntable structure for receiving a disk, a rotary shaft rotatable about a rotary axis for rotating said turntable structure,
a centering member movable in the rotary shaft direction for positioning the disk with respect to the rotary shaft; and
a guide portion on said turntable structure formed concentrically with respect to the rotary shaft, said guide portion being pushed and elastically deformed by the centering member during disk rotation and serves for guiding the centering member in the axial direction.

2. The turntable according to claim 1, wherein the rigidity of said guide portion is less than the rigidity of said centering member allowing for elastic deformation of said guide portion.

3. The turntable according to claim 2, wherein said guide portion has a thin part such that the rigidity of said thin part is reduced with respect to that of said centering member.

4. The turntable according to claim 1, wherein the material of said guide portion is softer than the material of said centering member thereby allowing for elastic deformation of said guide portion.

5. The turntable according to claim 4, wherein said guide portion is formed from a resin and said centering member is formed from a metal.

6. The turntable according to claim 4, wherein said centering member is formed of a polycarbonate and said guide portion is formed of a material softer than said polycarbonate.

7. The turntable according to claim 4, wherein said centering member is formed of a resin harder than polycarbonate and said guide portion is formed of a material softer than said polycarbonate.

8. The turntable according to claim 1, wherein a gap is provided inside said guide portion.

9. A turntable comprising:
a turntable structure for receiving a disk, a shaft rotatable about a rotary axis for rotating said turntable structure, said turntable structure having a guide portion;
a centering member dispose about said guide portion and rotatable in the rotary shaft direction for positioning the disk with respect to the rotary shaft;
said guide portion being concentric with said shaft and being elastically deformable by said centering member during rotation of the disk on the turntable structure and serves to guide said centering member in an axial direction.

10. A turntable according to claim 9, wherein the rigidity of said guide portion is less than the rigidity of said centering member to provide for elastic deformation of said guide portion.

11. A turntable according to claim 9, wherein said guide portion has first and second parts, said first part being thinner than said second part.

12. A turntable according to claim 11, wherein said guide portion has a terminating end, said thinner first part of said guide portion being juxtaposed to said terminating end.

13. A turntable according to claim 9, wherein the centering member is made of a material which is harder than the material from which said guide portion is made.

14. A turntable according to claim 9, wherein a space is provided radially inwardly of said guide portion.

15. A turntable according to claim 14, wherein the elastically deformed guide portion extends into said space.

16. A turntable according to claim 9, wherein said guide portion has an outer part having a surface which is non-parallel with said rotary axis.

17. A turntable comprising:
a turntable structure for receiving a disk, a shaft rotatable about a rotary axis for rotating said turntable structure, said turntable structure having a guide portion;
a centering member juxtaposed to said guide portion for positioning the disk with respect to the rotary shaft;
said guide portion being concentric with said shaft and being elastically deformable by said centering member during rotation of the disk on the turntable structure.
